(19) United States
(12) Patent Application Publication
(10) Pub. No.: US 2018/0113782 A1
(43) Pub. Date: Apr. 26, 2018

(54) ADAPTIVE WEB ANALYTIC RESPONSE ENVIRONMENT

(71) Applicant: Arizona Board of Regents for The University of Arizona, Tucson, AZ (US)

(72) Inventors: Joseph S. Valacich, Tucson, AZ (US); Jeffrey L. Jenkins, Provo, UT (US)

(73) Assignee: Arizona Board of Regents on Behalf of the University of Arizona, Tucson, AZ (US)

(21) Appl. No.: 15/568,731

(22) PCT Filed: Jun. 11, 2015
(86) PCT No.: PCT/US15/35287

§ 371 Date: Oct. 23, 2017

Related U.S. Application Data
(60) Provisional application No. 62/010,853, filed on Jun. 11, 2014.

(51) Int. Cl. G06F 11/34; G06F 17/30; G06F 8/38

(52) U.S. Cl. CPC G06F 11/3452; G06F 11/3438; G06F 8/38; G06F 11/3447; G06F 17/3089; G06F 11/3419

(57) ABSTRACT

The present invention provides a method for determining ease of usability of an interactive program or software. In particular, one or more of the input device usage characteristics are used to determine the ease of usability. Using the methods of the invention, one can determine the ease of use between different versions of a program and/or different arrangements of interactive tasks within a program.

### CROSS-REFERENCE TO RELATED APPLICATIONS

This application claims the priority benefit of U.S. Provisional Application No. 62/010,853, filed Jun. 11, 2014, which is incorporated herein by reference in its entirety.

### FIELD OF THE INVENTION

The present invention provides a method for determining ease of usability of an interactive program or software.

### BACKGROUND OF THE INVENTION

The extent to which a technology is free of effort is a hallmark of many successful systems and websites. In an era of instant information and online services, ease-of-use (EOU) is particularly salient and important. If users cannot quickly accomplish their goal with minimal effort, they will often leave a website. In one study of 205,873 webpages, each with over 10,000 visits, it was found that users are most likely to abandon a webpage within the first 10 seconds; notably, with low EOU being a key contributor to abandonment. Studies have also shown that minimizing effort is generally more important to users than maximizing the quality of information they find. Further, it was also found that websites that lack EOU often discourage continued use. Given its importance, billions of dollars are spent annually on usability testing to make user interfaces easier to use.

To understand system acceptance and improve interface usability, researchers and practitioners use various measures to assess EOU. One common measure of EOU is perceived ease-of-use (“PEOU”)—the extent to which a person believes that using a technology will be free of effort. PEOU is widely validated and cited, and is typically measured through surveys or other self-report instruments. It some situations, PEOU provides an ideal measure of a system's EOU. However, in other situations, soliciting self-report measures can be challenging. For example, in “live” websites, surveys asking self-report measures can be perceived as being an interruption, annoying, cumbersome, or time-consuming. As a result, asking survey questions on live websites can yield low response rates and are often biased toward those who had highly positive (or negative) experiences. Even in some non-live research settings, self-report measures may be influenced by various biases.

To help address these challenges of self-report instruments, research has stressed the importance of obtaining measures of actual behaviors. Currently, there is no reliable and/or objective method of measuring ease-of-use for a particular website (or program).

Accordingly, there is a need to objectively and/or reliable measure ease-of-use of a particular website (or program). Such a method would allow one to provide a better website (or program) to the user.

### SUMMARY OF THE INVENTION

The present inventors have discovered that ease-of-use can be objectively and/or reliably measured by analyzing users' input device usage, e.g., mouse cursor movements. In one particular embodiment, cursor movements can be captured via a computer mouse, touchpad, touchscreen, or other computer input devices controlled by the user's hand or finger. For the sake of clarity and brevity, the present invention is described herein with primary focus on indicators of ease-of-use that can be captured by the computer mouse. However, it should be appreciated that any other type of input devices (e.g., touchscreens, touchpads, in-air sensors such as the Microsoft Kinect, game controllers, accelerometers and gyros in smart phones) can also be used, either alone or in combination, to determine information about hand movements thereby providing an unbiased or objective, non-invasive, continuous, mass-deployable EOU measurement.

Mouse cursor movements have been suggested to provide “high-fidelity, real-time motor traces of the mind [and] can reveal ‘hidden’ cognitive states that are otherwise not availed by traditional measures”. By using the “Attentional Control Theory” and the “Response Activation Model,” the present inventors have discovered that lower EOU causes users' mouse movement precision to decrease. The present inventors have also discovered indicators of movement precision that can be automatically analyzed from users' mouse cursor movements using JavaScript embedded in webpages.

### BRIEF DESCRIPTION OF THE DRAWINGS

FIG. 1 shows area under the curve (AUC), additional distance (AD) and maximum deviation (MD) for an example cursor movement.

FIG. 2 illustrates idealized response trajectory in an example webpage navigation where 100, 200, 300, 400 and 500, show idealized response trajectories and • circles denote starting and ending points.

FIG. 3 is Table 1 showing results for experiment 1, population 1.

FIG. 4 is Table 2 showing the results for experiment 1, population 2.

FIG. 5 shows comparison of models where the first column represents scenarios and the right column represents different model tests.

FIG. 6 is a table showing a list of tasks that were presented in random order to participants in Study 2. The left column shows the task codes and the right column shows the instructions associated with the task codes.

FIG. 7 shows flow of Study 2 field test.

FIG. 8 is a table showing baseline ranking and summary of comments themes. Column 1 shows ranking, column 2 shows task (or page) and column 3 is listed problems (and count of problems).

FIG. 9 is a table showing rankings of tasks from lowest ease-of-use to highest ease-of-use based on average values for each instrument in Study 2.

FIG. 10 is a table showing number of rankings consistent with the baseline rank.

FIG. 11 is a table showing weighted Kappas comparing each statistic (PEOU, NAUC, NAD, and MD) to the baseline ranking.

FIG. 12 is a table showing tests for equality of weighted Kappa with Bonferroni correction on p-values.

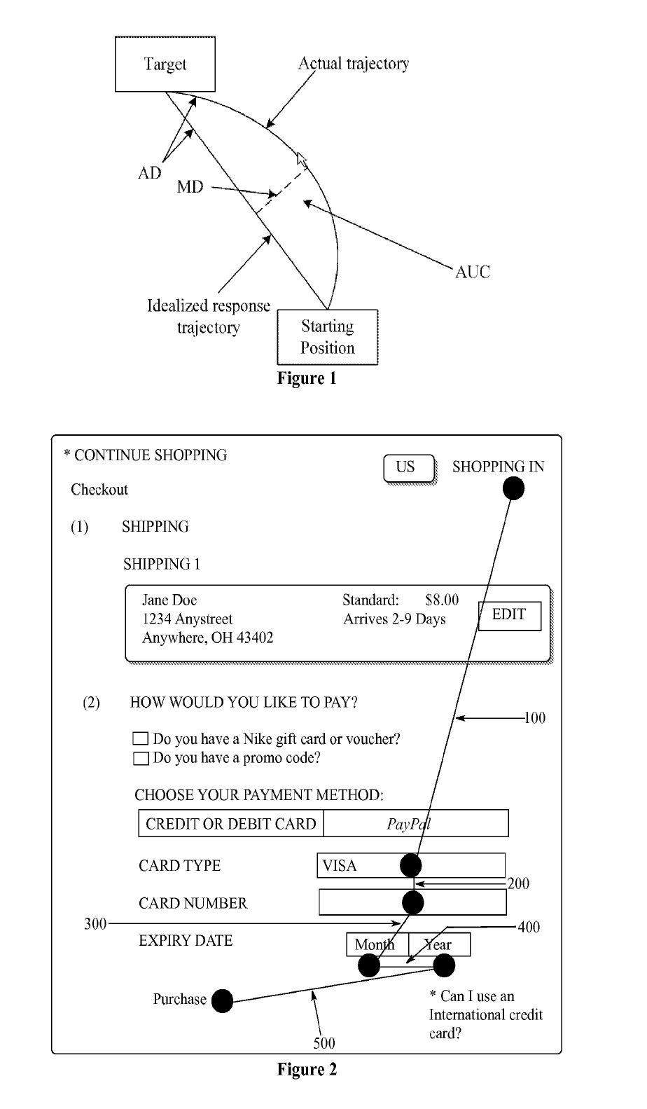

### DETAILED DESCRIPTION OF THE INVENTION

As used herein the terms “program” and “software” are used interchangeably herein to refer to a computer program that is designed for interactive input from a user. Exemplary programs include, but are not limited to, stand alone programs, online programs (such as web-sites and web-site based programs), as well as any computer programs that require a user input.

To help address the challenges of self-report instruments, research has stressed the importance of obtaining measures of actual behaviors. The present invention provides an objective and unobtrusive measure of a variety of emotional and cognitive reactions—including ease-of-use, user competency (efficacy), negative emotional reactions such as anger and frustration, and positive emotional reactions such as happiness and excitement—when interacting with various types of information systems based on the analysis of users' input device usage characteristics, such as mouse movements. Measurement of different types of emotional and cognitive reactions is context dependent. Evidence of users' emotional and cognitive reactions when interacting with a system is manifested in changes in a user's hand movements captured via the computer mouse, touchpad, touchscreen, or other computer input devices controlled by the hand. For example, when users experience a negative emotional reaction, their mouse movement precisions decreases. Likewise, from a cognitive perspective, when a person is answering questions on a test, changes in hand movements that would result in different amounts of delay, lingering, attraction toward other answers, and commitment (clicking) for a particular questions would be indicative of differences in efficacy of understanding of a particular concept. For brevity and clarity, the present invention is described in references to primarily on indicators of various emotional and cognitive reactions that can be captured by the computer mouse, although other input devices (e.g., touchscreens, touchpads, in-air sensors such as the Microsoft Kinect, game controllers, accelerometers and gyros in smart phones) can also be used to provide rich information about hand movements.

Without being bound by any theory, it is believed that analyzing users' mouse movements provides high-fidelity, real-time motor traces of the mind and can reveal ‘hidden’ cognitive states that are otherwise not availed by traditional measures. Variations in ease-of-use, efficacy, emotional, and/or cognitive states causes measurable changes in users' input device usage characteristic(s), such as mouse movements. Thus, in some embodiments of the invention, these input device usage (e.g., mouse-movement) characteristics is extracted and modeled together as a valid and reliable measure of a particular emotional- or cognitive-based reaction (e.g., ease-of-use, computer efficacy, negative and positive emotions).

Some aspects of the invention are based on the discovery by the present inventors that various types of emotional and cognitive responses cause objectively measurable changes in a user's input device usage characteristics. For example, in the context of measuring an information systems ease-of-use the user's mouse-movements based on four characteristics (e.g., normalized area under the curve, normalize maximum deviation, normalized additional distance and flips) yield useful information on ease-of-use of a particular interactive computer software/program. In other contexts, such as efficacy, similar mouse-based characteristics will provide a valid measurement of the focal emotional reaction.

One particular application of the invention provides a method for detecting emotional and/or cognitive responses to a computer program. The method generally includes: collecting input device usage characteristics of a user during an interactive computer session; and analyzing the input device usage characteristics of the user to determine the ease of use of a computer program. Typically, the input device comprises a point-and-click device.

Alternatively, the input device can include mouse, touch screen, track ball, touch pad, joystick, stylus, or a combination thereof.

Some of the input device usage characteristics that are useful in the method of invention include, but are not limited to, normalized area under the curve, normalized maximum deviation, normalized additional distance, flips, pressure, cursor location, click latency, acceleration (e.g., of mouse movement), speed, idle time, keystroke dwell time, keystroke transition time, areas of the page clicked on or hovered over, and a combination thereof. In one particular embodiment, the following input device usage characteristics are used either alone or in combination: normalized area under the curve, normalized maximum deviation, normalized additional distance, and flips.

In some embodiments, the step of analyzing the input device usage characteristics comprises comparing said input device usage characteristics of the user to a control input device usage characteristics. The control input device usage characteristics can include input device usage characteristics of said user in a previous interactive computer session. Thus, the user's own previous input device usage characteristic is compared to the use of a new computer software/program. Thus, in some embodiments, the user's input device characteristics are collected and stored to serve as a control.

Alternatively, the control input device usage characteristics can be the average input device usage characteristics of a plurality of users of the same computer software/program. In this manner, general population sample is used as a control. In some instances, both the user's own input device usage characteristics and the average input device usage characteristics can be used in combination.

Still in another embodiments, the step of analyzing the input device usage characteristics comprises comparing said input device usage characteristics of the user to an idealized or optimal input device usage characteristics, e.g., mouse-movement trajectory. Thus, one can compare the deviation of the user's input device usage characterization from the user's previous or average user's deviation from idealized input device usage characteristics.

Another aspect of the invention provides a method for developing an interactive computer software. Such method can include (i) collecting input device usage characteristics of a plurality of users using an interactive computer software; (ii) analyzing the input device usage characteristics of the plurality of users to determine emotional and cognitive responses to said interactive computer software; (iii) optionally modifying the interactive computer software; and optionally repeating said steps (i)-(iii). The number of iteration of steps (i)-(iii) can be as many as desired to obtain a desired objective for the program/software.

Typically, the interactive program/software is a web-based software, but can also include standalone desktop applications and mobile applications that run on tablets and smartphones.

Another aspect of the invention provides a system for determining or collection information on the emotional and/or cognitive state of a user of an interactive computer program/software. As used herein, the term “interactive” refers to a system, program or software that requires an active input from the user. The system typically includes, an electronic device that includes one or more input devices that is capable of detecting motion of a subject's hand or finger. Typically, the system also includes a data interception unit configured to intercept inputs from a user. The data interception unit is configured to passively collect an input device usage characteristics. The system can also include a behavior analysis unit operatively coupled to said data interception unit to receive the passively collected input device usage characteristic.

The system can also include a behavior comparison unit operatively coupled to said behavior analysis unit. The monitoring system dynamically monitors and passively collects input device usage characteristic information, and translates said input device usage characteristic information into representative data, stores and compares different results, and outputs a result associated with a user's emotional or cognitive state when using the interactive program/software.

Some aspects of the invention are based on the discovery by the present inventors on how EOU influence users' input device usage (e.g., mouse cursor movements). Users' input device usage (e.g., mouse cursor movements) can be used to differentiate between higher and lower EOU. It was also found that EOU is related to user's cognition and hand movements. By using these discoveries, one can predict how EOU influences movement precision and defines associated relevant measures. In one experiment, the present inventors found that lower EOU decreases movement precision in terms of normalized area under the curve (NAUC) and normalized additional distance (NAD), and that these measures can predict users' perceived intentions to use the system and usefulness of the system. In another study, the present inventors found that NAUC and NAD can adequately differentiate EOU among different system components in a live, real-world, usability testing context.

It is generally believed that perceived ease of use (“PEOU”) is one of the most common and validated perceptual measures of effort when examining technology acceptance. Since its inception, PEOU has been examined or referenced in thousands of studies, and shown to influence a wide variety of important user outcomes, such as initial user acceptance and continued system use. A meta-analysis conducted on the technology acceptance model (TAM) concluded that the influence of PEOU on behavioral intentions can vary depending on a system's characteristics. Based on the 67 papers examined, 30 (˜45%) reported a non-significant relationship (p>0.05 level) between PEOU and behavioral intentions. In this analysis, PEOU was found to primarily influence behavioral intentions through the mediator of perceived usefulness (average β=0.479, z=12.821, p<0.001, n=12,263). However, when accounting for the type of system usage (e.g., job-office applications, general, and ecommerce/internet applications), PEOU was found to be important in internet applications, which is almost always significant when predicting behavioral intentions. Additionally, when system use is an internet application, the effect size is nearly double that of other system use—types (average β=0.258, z=5.646, p<0.001, n=4,472). Clearly, EOU is a important aspect of internet/e-commerce adoption.

In many situations, PEOU provides an ideal measure of EOU. However, as with all instruments, self-report measures present some challenges in certain scenarios, and particularly when evaluating the EOU of systems in real-world, non-controlled settings. For example, some commercial websites solicit visitors to complete an online survey at the end of an interaction to capture usability measures. Typically, response rates are low (often only 2-5%) and are frequently biased toward extremely positive or negative experiences. Further, if surveys are solicited too often, they may be perceived as annoying, possibly discouraging future use of the system. In some situations, such self-report measures may also be influenced by social-desirability bias (e.g., answering questions in a manner that will be viewed favorably by others), priming/wording bias (e.g., having the question prime thoughts that would normally not have been primed otherwise, or availability bias (e.g., having one thought unproportionately bias one's overall evaluation because it is brought to mind easier).

To help address these challenges, research has repeatedly stressed the need to corroborate self-report measures with behavior-based measures. The present inventors have discovered that users' input device usage characteristics (e.g., mouse cursor movements) can be used to behaviorally measure EOU and can be collected unobtrusively in users' natural settings. Previous research in neuroscience and psychology has unequivocally demonstrated that linkages exist between cognitive processing and hand movements. Thus, it was found that monitoring mouse cursor movements can give insight into how users devote their attention during system use. For example, one research suggested that attention and action are intimately linked. Other studies have shown mouse cursor movements give insight into where users' devote their attention and where the eye is gazing.

Attentional Control Theory can be used to explain how EOU influences users' attention and thereby mouse cursor movements. Attentional Control Theory (ACT) was initially used to explain how anxiety influences attentional control and thereby cognitive performance. The term “attentional control” refers to peoples' ability to choose what they pay attention to and what they ignore. As people experience anxiety, their attention shifts from being goal-directed to being stimulus-driven in search for threat-stimuli in the environment. This results in a greater distribution of attentional resources toward threat-related stimuli at the expense of attention allocated to the task. In neurological terms, anxiety decreases the efficiency of the brain's attentional inhibition and shifting functions, which decreases attentional control. The term “inhibition” refers to the function of the brain that prevents stimuli unrelated to a task from capturing a person's attention. The term “shifting” refers to allocation of attention to the stimuli that are most relevant to a task. The theory further posits that processing more stimuli in the environment reduces the processing and storage capacity of the center processing unit of working memory, which may therefore decrease cognitive performance.

ACT has been widely validated. Although the theory was originally used to describe how anxiety influences attentional control, it has been extended to explain how other outcomes (mostly negative emotional responses) decrease attentional control, including frustration, sadness, fear, and depression. In an information systems context, ACT has been used to help explain how cognitive load and anxiety is negatively correlated with EOU in synchronous learning games. Importantly, ACT is oft used to explain the influence of cognitive and emotional states on motor movement planning (e.g. hand movements), and thereby may have particular relevance for predicting mouse cursor movements in this study. For example, based on ACT, past research has explained how trait anxiety influences motor efficiency in the hand and fingers, the influence of pressure on visuo-motor control—i.e., using visual feedback to guide motor movements, and how physiological pressure influences corticospinal motor tract excitability and performance of finger movements, to name a few. Building on these studies, the present inventors have extended ACT to determine how EOU influences users' attentional control, and how such changes influence the precision of mouse cursor movements.

The present inventors have discovered that lower EOU elicits a shift in attention from being goal-directed to being stimulus-driven, which decreases attentional control. ACT suggests that “stimuli may produce anxiety in participants who perceive them as interfering with performance or as signaling a difficult task.” Lower EOU is one such barrier that may interfere with performance or signal that a task is more difficult than desired, and thereby induce anxiety. As such, consistent with ACT, lower EOU may result in anxiety, which decreases attentional control.

Furthermore, per the principle of least effort, people have a natural tendency to divert their attention from high-effort tasks. Effort resulting from lower ease-of-use should not be confused with challenge. Challenge is defined as an efficacy motivation that leads an individual to develop competence and feelings of self-efficacy in dealing with one's environment. Effort is defined as strenuous physical or mental exertion. Whereas challenge may increase attention to a stimulus, effort decreases attention to a stimulus. Furthermore, effort and challenge are not mutually exclusive; challenge may include motivation to find a less-effortful way to accomplish a task. The principle of least effort suggests that people naturally prefer and choose the path of least resistance or effort. The principle is based on the premise that humans have limited resources (e.g., time, cognitive effort, and abilities), and choose alternatives that will minimize effort and thereby free resources for other tasks. This tendency to free resources is almost always present. Without being bound by any theory, it is generally believed that even if other tasks are not currently competing for resources, humans will naturally free resources so that they are available for future use, such as responding to unanticipated events. People's desire to minimize effort is shown to be often greater than their desire to achieve an optimal solution.

Typically, one's tendency to avoid a behavior increases as the effort associated with that behavior increases. Again without being bound by any theory, it is believed that as effort increases, more cognitive resources are consumed and the brain is less capable of responding to other, sometimes important, stimuli. Hence, as effort increases, people are more motivated to find ways to accomplish the goal with less effort and are more easily diverted by less effortful tasks. To search for a path of less resistance, people distribute their attentional resources toward stimuli in the environment, decreasing the brain's attentional inhibition and shifting functions. This is often described as the information search stage in the ill-structured problem solving process, which involves exploring the problem space and task environment for possible solutions. While allowing people to discover less resistant paths of goal attainment, the decreased inhibition and shifting functions also decrease attentional control. People are less able to focus their attention on the task at hand, and are more likely to give attention to other stimuli in the environment.

A decrease in attentional control leads to a decrease in movement precision. The Response Activation Model (RAM) suggests that all stimuli (e.g., a link, image, etc.) with actionable potential that capture a user's attention will prime movement responses. To prime a movement response refers to subconsciously programming an action (transmitting nerve impulses to the hand and arm muscles) toward or away from the stimulus. This priming causes the hand to deviate from its intended movement (i.e., decreases the precision of movement), as the observed hand movement is a product of all primed responses, both intended and non-intended. For example, if one is intending to move the mouse cursor to a destination on the page, and other stimuli on the page catch the user's attention, the hand will prime movements toward these other stimuli. Together, this priming will cause the trajectory of movement to deviate from the path leading directly to the intended destination. Throughout the movement, the brain will compensate for these departures by automatically programming corrections to the trajectory based on continuous visual feedback, ultimately reaching the destination. Thus, decreased attentional control caused by lower EOU will result in less precise movements.

Additional objects, advantages, and novel features of this invention will become apparent to those skilled in the art upon examination of the following examples thereof, which are not intended to be limiting.

### EXAMPLES

Two studies were conducted to test the hypotheses. Study 1 was designed to test the hypotheses in a website with an ease-of-use manipulation. The experiment found that lower EOU increases the NAUC and NAD of users' mouse cursor movements, but not necessarily MD. Furthermore, assessing the utility of the measures, the study showed that NAUC and NAD can predict users' intentions to use the system and the perceived usefulness of the system. Study 2 cross-validates these results in a field test, using NAUC, NAD, and MD to measure EOU of different components of a commercial software system. The results again showed that NAUC and NAD are indicative of EOU. Furthermore, the test showed that NAUC and NAD can be used to differentiate between lower EOU and higher EOU components of a system, again demonstrating the utility of the measures.

Study 1: Study 1 tests the hypotheses in an experiment that manipulated EOU in an e-commerce website. Participants were randomly presented either a) a lower EOU version of the website, or b) a higher EOU version of the website. While participants navigated the website to accomplish a common goal, mouse cursor movements were captured and analyzed. The analysis then compared whether the EOU manipulation influenced the precision of users mouse cursor movements in terms of NAUC, NAD, and MD. The results were cross validated with two different populations.

Participants were asked to engage in a study that would require them to navigate a website to accomplish a task and then fill out a short usability survey. Upon agreeing, participants were led to an online system that presented them with the following instructions: “Pretend you own a laptop with a 15.6-inch screen. You broke your laptop screen and need to buy a replacement to fix it. Your task: navigate the website on the next page to purchase the replacement laptop screen. Please write down the following detail so that you remember what replacement part you need to find on the website: Replacement part needed: 15.6-inch replacement screen for your Dell Inspiron 1546 laptop.”

After reading the instructions, participants clicked on the ‘next’ button that led them to the computer store website. The website was created by the research team using a professionally-made e-commerce template to ensure that no one had previous experience with the system. The website had four pages (not shown). To accomplish the goal of finding the replacement laptop screen, users clicked on the order parts link on Page 1, leading to Page 2. On Page 2, users clicked on the link that led to the replacement screens (Page 3). On Page 3, users specified the model and screen size of the replacement part and clicked submit to go to Page 4. Finally, users clicked on the purchase button to buy the displayed replacement part on Page 4, which then led to the post survey.

Prior to beginning their task, participants were randomly assigned to one of two conditions of the website: a) a lower EOU condition, or b) a higher EOU condition. The same website template was used for both conditions; however, information clutter was increased in the lower EOU condition to increase effort. Although lower EOU may occur for several different reasons, one source of lower EOU comes from cluttered interfaces. Cluttered interfaces increase effort by requiring users to process more information to find the information they are looking for. Cluttered interfaces have been shown to impose costs by increasing retrieval demands on memory, and thereby increase effort. Interface clutter has been widely shown to be a deterrent of EOU.

JavaScript based on the jQuery library (jquery.com/) was imbedded in each webpage to capture mouse movements as participants navigated the website. JQuery can easily be implemented in almost all types of webpages for research or pragmatic purposes. Using the jQuery “.mousemove( )” function, the code captured the x-, y-coordinate pairs and timestamps at millisecond intervals (typically at a rate higher than 70 Hz) as the participants moved the mouse. The script then sent this data to a web service, developed by the research team, for further analysis.

The web service normalized the x-, y-coordinate pairs to a standardized grid to help account for different screen resolutions. In this experiment, the web service rescaled the x-, y-coordinate pairs to an 8×6 grid: the x-axis went from −4 to 4, and the y-axis went from −3 to 3. The mouse's starting position (where the mouse was when the page loaded) was mapped to a standard starting coordinate (i.e., 0, 0).

Next, the idealized response trajectory was automatically calculated for each participant. The idealized response trajectory consists of straight lines connecting estimated endpoints in the user interaction (i.e., points where the user likely intended to reach on the page). The starting point of the first segment was the location of the mouse cursor when the page finished loading. The other endpoints were estimated using two heuristics: where the user a) clicked on the page, and b) stopped moving. A stop in movement is denoted by a pause between recorded movements greater than 200 ms. Two-hundred milliseconds was chosen as an interval based on an analysis by the present inventors of over 6,800 movements that people made between destinations (i.e., endpoints) in various settings and on their personal computers. The analysis indicated that on average, movements between two destinations had natural pauses on average of 19.822 ms with a standard deviation of 61.813 ms. Such pauses between recorded positions may be due to the mouse cursor sampling rate, people repositioning their hand to continue moving the mouse, or other reasons that occur during a normal movement between two points. Two-hundred milliseconds is approximately three standard deviations from the mean, suggesting with a probability level of p<0.002 that the break in movement greater than 200 ms is not a part of the normal movement between endpoints. For this study it is believed that these heuristics are sufficient for measuring differences in movement precision.

NAUC, NAD, and MD were then calculated based on the actual mouse trajectories' deviation from the idealized response trajectory. NAUC was calculated by first subtracting the area of the actual mouse cursor trajectory from the area of the idealized response trajectory. The area of the idealized response trajectory is equal to the summation of all of its segments' areas. The area of each segment of the idealized response trajectory is computed by calculating the area of the right triangle with the beginning and ending point of that segment on the hypotenuse. The area of the actual trajectory was calculated through a Riemann sums bootstrapping technique. The idealized response trajectory area was then subtracted from the actual trajectory area to find the area difference between the trajectories. Finally, after adding together all of the areas under the curve for each segment, this value was divided by the total distance of the complete idealized response trajectory to normalize for distance.

NAD was calculated by subtracting the total distance required to travel each segment of the idealized response trajectory from the total distance traveled on the actual trajectory. The Euclidean distance formula was used to calculate the distance between the start and the endpoint for each segment of the idealized trajectory, and between each point in the actual trajectory. The total additional distance was then divided by the total distance of the idealized response trajectory to normalize for distance.

MD was calculated in several steps. The system first computed the line equation between each pair of associated endpoints on the idealized response trajectory. Then, for each point (x, y-coordinate) on the actual trajectory, the system calculated the equation of a perpendicular line that goes through the x-, y-coordinate and intercepted the line equation of its associated idealized response trajectory segment. Through substitution in the two line equations, the point of interception was derived and the distance was calculated between the x-, y-coordinate position on the actual trajectory and the calculated intercept point on the idealized response trajectory using the Euclidean distance formula. Given a set of all distances from every point on the actual trajectory to its corresponding idealized response trajectory segment, MD was determined by finding the greatest value in this set.

In a post-survey, participants answered questions to measure the perceived ease-of-use of the website as a manipulation check. In addition, items were gathered to measure perceived usefulness and intentions to use the system for a supplemental analysis.

The experiment was conducted with two different sample populations to cross-validate and extend the generalizability of the results. First, the experiment was conducted with students from a large university. Second, the experiment was administered on Amazon's Mechanical Turk to extend the generalizability to a more diverse population.

Population 1: The experiment was first conducted using students from a large private university in the USA. Students represent an age group and demographic that commonly uses the internet; 97% of student-aged people (18-29) use the internet in the United States, and 97% of people with a college degree use the internet, which is significantly more than most other age groups and educational levels. Therefore, the student population represents an important internet demographic for examining the EOU of websites. Furthermore, students have been argued to be an appropriate population to establish the relationships among constructs. As one purpose of this study is to better understand the relationship between EOU and mouse cursor precision, students were deemed to be an appropriate sample population.

Forty-three students participated in the test; 22 participants in the lower EOU treatment group and 21 in the higher EOU treatment group. Students were recruited from an undergraduate subject pool from classes in the management school. As compensation, students were given 0.25% extra credit applied to a participating management course of their choice. Approximately 69% of the participants were male, 83% were from the USA, and the average age was 21. The most represented disciplines were accounting (31%), management (19%), recreational management (12%), and information systems (12%).

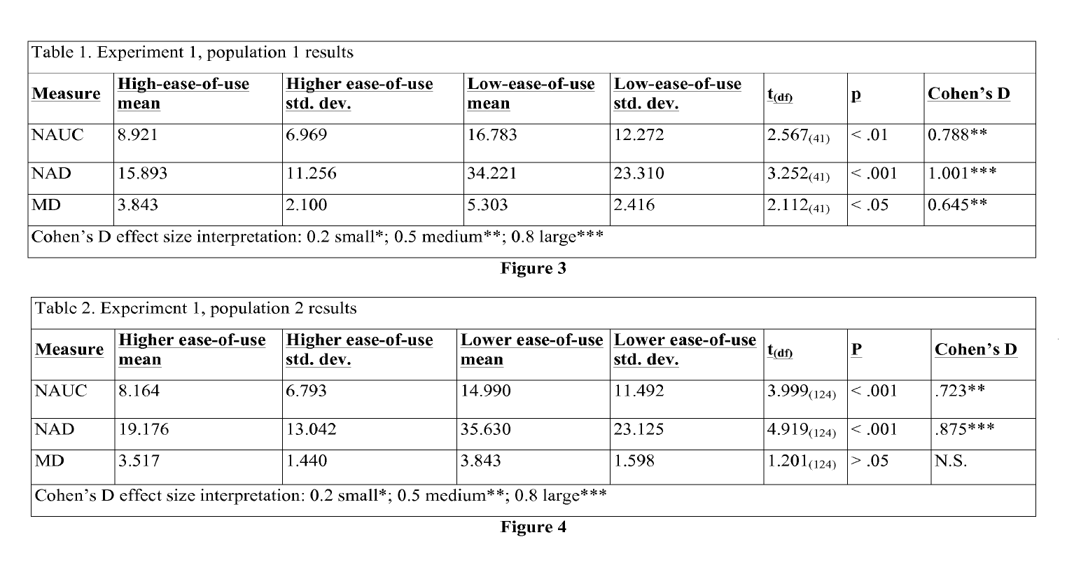

Manipulation checks were first performed using PEOU to measure effort. The analysis demonstrated that participants in the lower EOU treatment reported significantly lower PEOU than participants in the higher EOU treatment, t₍₄₁₎=−12.614, p<0.001. Thus, the manipulations were successful. Next, NAUC, NAD, and MD were analyzed using independent-sample t-tests to explore whether the manipulation of EOU influenced mousing precision. The results are shown in FIG. 3. As can be seen in FIG. 3, H1 (NAUC), H2 (NAD), and H3 (MD) were all supported.

Population 2: Building on the prior results, a larger-scaled study was conducted with a more diverse population to cross validate and increase the generalizability of the results. For this study, participants were recruited from Amazon's Mechanical Turk (MTurk). The diversity of the MTurk participant pool is larger than that of typical undergraduate college samples, and the data are as reliable as those collected using other methods, if not more so. Using MTurk to recruit participants has been deemed appropriate for random sample populations. Likewise, it has been found that the behavior of MTurk respondents closely resembles that of participants in traditional laboratory experiments. Furthermore, MTurk is often used in commercial website usability testing and thus is an appropriate population to mimic usability testing in a real (non-research) setting.

One-hundred-twenty-six participants were recruited from Mechanical Turk for this experiment; 63 in each treatment group. Forty-eight percent of the participants were from the United States, 37% from India, and 15% from various other nations. Approximately, 53% of the participants were female and the average age was approximately 35. All participants were paid US$0.35 for a 2 to 3 minute task—equaling a US $7-$10.50 hourly wage.

Manipulation checks were first performed using PEOU to measure overall effort. The analysis demonstrated that participants in the lower EOU treatment reported significantly lower PEOU than participants in the higher EOU treatment, t₍₁₂₄₎=−4.780, p<0.001. Thus, the manipulations appeared again to be successful.

The analysis next examined whether there was a difference in NAUC, NAD, and MD between the two treatment groups. Means of the two treatment groups were compared using an independent-sample t-test for each of the mousing statistics. See FIG. 4. As can be seen in FIG. 4, H1 (NAUC) and H2 (NAD) were again supported. However, H3 (MD) was not supported with this population.

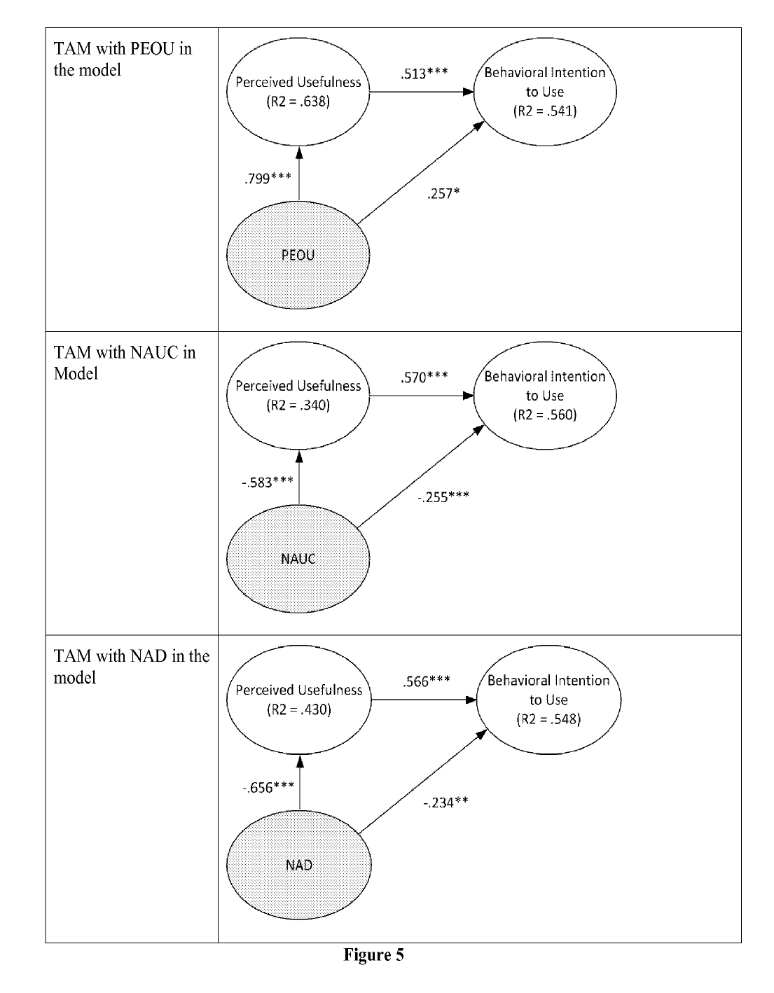

Supplemental Analysis: A supplemental analysis was conducted to explore the efficacy of NAUC and NAD in measuring EOU. The Technology Acceptance Model (TAM) predicts that PEOU influences Perceived Usefulness (PU) and intentions to use a system. If NAUC and NAD are accurate measures of EOU, they would also predict intentions and perceived usefulness similarly to PEOU. These propositions were tested by creating three structural models. In the first, the normal TAM was replicated with PEOU, PU, and intentions. In the second, PEOU was replaced with NAUC in the model. Finally, in the third, PEOU was replaced with NAD. The three models are displayed in FIG. 5. The results shown in FIG. 5 indicate that all three models predict the dependent variables in a similar. While the NAUC and NAD models appeared to explain the same or slightly more variance in intentions than did the PEOU-based model, but possibly less variance in PU, all models explained more than 30% of variance in both intentions and PU.

Study 2: To extend the generalizability of Study 1 to a broader EOU context and to a likely industry scenario, a field test was conducted to evaluate the EOU of an online commercial software application. The purpose of the experiment was to test the efficacy of NAUC, NAD, and MD in differentiating between the EOU of different components of the system.

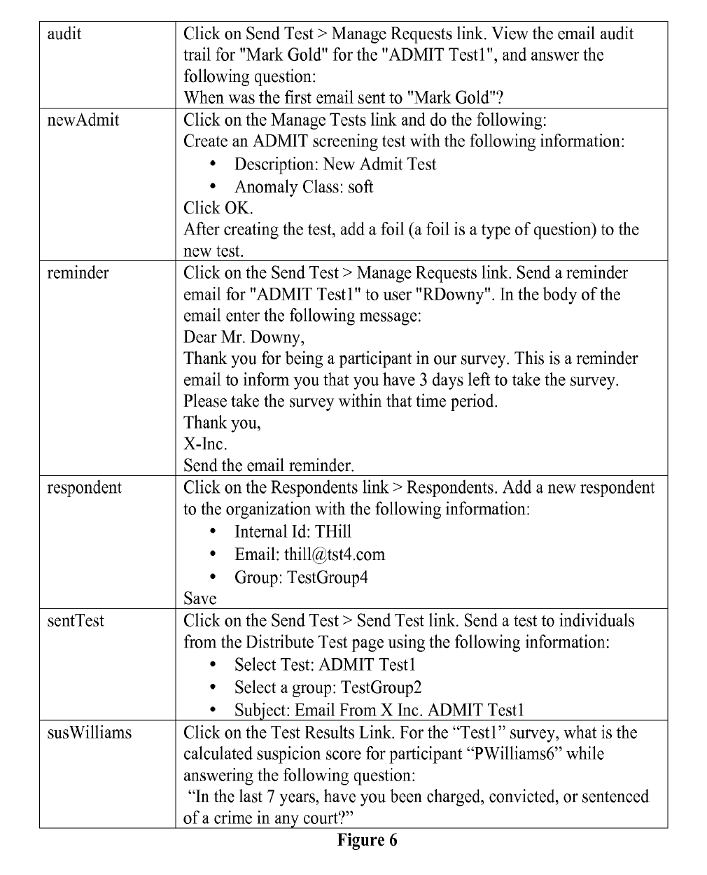

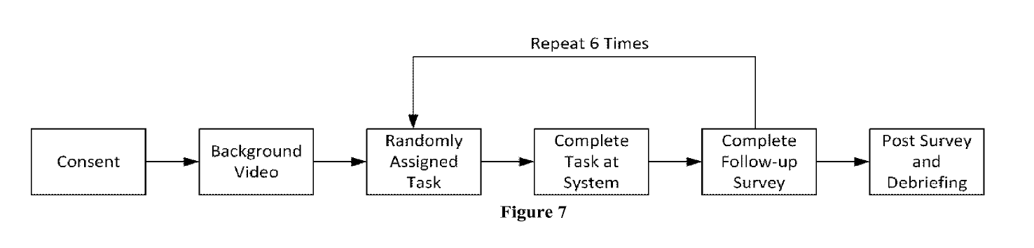

The field test was conducted in collaboration with a small privately-held corporation who had released a new beta-prototype of an online administrative portal for a suite of security screening tools. The corporation (hereafter referred to as “X Inc.” to preserve anonymity) provides specialized online survey-based screening services (e.g., pre-employment screening, annual integrity screening, security clearance screening) for organizations. The X Inc. administrative portal compiles analytics to identify suspicious responses in the screening process. X Inc. users' (e.g., HR representatives, managers) can login to the administrative portal to complete various tasks related to administrating tests (see FIG. 6 for a list of tasks evaluated in this study). As with most small- and medium-sized corporations, X Inc. does not have an extensive usability testing laboratory or the resources necessary to hire a professional testing firm to thoroughly assess the portal's usability. As such, X Inc. is an ideal candidate for utilizing mouse cursor movements to remotely and unobtrusively assess its portal without any cumbersome procedures or costly equipment.

To conduct a remote usability test of the administrative portal, X Inc. temporarily inserted a JavaScript library developed by the research team into each page of the portal. The JavaScript library utilized JQuery functions to capture users' mouse cursor movements and sent them to the researchers' web service (along with the page id) via an AJAX call each time a person changed pages (moved to a different view or page). The web service then calculated and stored the movement precision for each page for future evaluation as described in Study 1.

Participants were sent a link via email to a questionnaire that would guide them through the usability test. The questionnaire first required that all participants watch a video that described the X Inc. screening software as background information. After the video was finished, the questionnaire gave participants a username and password to access the administrative portal. The survey then presented 6 tasks, one at a time, in random order for participants to complete using the administrative portal (see FIG. 6 for a list of tasks). After completing each task in the administrative portal, participants immediately completed a survey that assessed the PEOU of the task and allowed participants to leave comments regarding the task's EOU. After completing all six tasks, participants completed a post survey (see FIG. 6). The post survey had participants again rank the 6 tasks from lowest EOU to highest EOU and gathered demographic information.

In collaboration with X Inc. and the university, the software was tested by management students. Management students were chosen because they most closely represent potential users of the software—future managers and human resource representatives. A total of 40 students completed 6 tasks each, for a total of 240 observations. As the data was collected outside the laboratory (online using participants' personal computers), technical limitations on one participant's computer prevented collecting or transferring the mouse movement data to our data collection/analysis web service. Outliers were then screened, removing any observations in NAUC, NAD, and MD that were more than three standard deviations away from each task's mean (to help eliminate behaviors like moving the mouse in circles, etc.). This resulted in 227 valid responses.

Sixty percent of the participants were male; approximately 88% were from the United States. Approximately 43% of the participants were majoring in Business Management, 23% in organizational behavior/human resources, 15% information systems, 10% accounting, and 10% finance. The average age was 22.52, and participants had completed on average 2.75 years of college education. None of the participants had prior experience with the software.

Analysis and Results: Analysis consisted of two parts. First, the data was analyzed to test the hypotheses and explore research question 1: how does EOU influence users' mouse cursor movements? To do this, the Pearson product-moment correlations were calculated to explore whether participants' self-reported PEOU is significantly correlated with participants' mouse cursor movement precision. As expected, the results indicate that PEOU was significantly correlated with NAUC, r(225)=−0.371, p<0.001, significantly correlated with NAD, r(225)=−0.200, p<0.001, and significantly correlated with MD, r(225)=−0.024, p<0.05. As PEOU is a measure of EOU, this lends support the discovery by the present inventors that lower EOU results in greater NAUC (H1), NAD (H2), and MD (H3).

Second, an analysis was conducted to explore research question 2: can users' mouse cursor movements be used to differentiate between higher and lower EOU? To do this, each task was ranked from lowest to highest EOU using participants' self-reported ranking data and free response data. This resulted in a ranking assigned to each task ranging from 1 (lowest EOU) to 6 (highest EOU). Participants' rankings were averaged together to generate a population ranking The results of the average population rankings from lowest to highest EOU were (average rank shown in parentheses): newADMIT (1.489), respondent (2.137), susWilliams (3.905), Audit (4.056), SentTest (4.304), and Reminder (5.250).

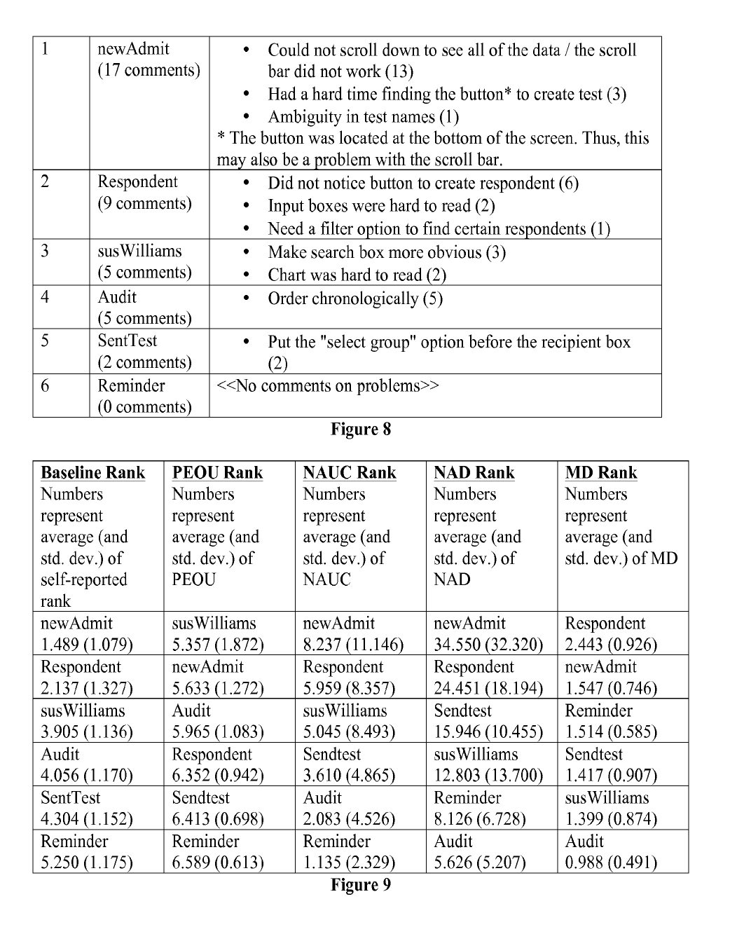

To help confirm whether these rankings accurately represented the comparative difficulty of the tasks, the optional free-response question data collected after each task were summarized. The free response question allowed participants to leave a comment regarding the EOU of the task. FIG. 8 summarizes the major themes of problems and the number of comments for each. The observations corroborate the rankings The tasks rated as having the lowest EOU, also have the most negative comments about EOU, and vice versa. This comparative rank of EOU was used for the different tasks as a baseline for the remainder of analysis (referred to as the “baseline rank” hereinafter).

How well each instrument—NAUC, NAD, and MD along with PEOU for comparison—differentiated tasks' EOU consistently were explored with the baseline ranking. To do this, PEOU, NAUC, NAD, and MD were averaged at a population level to rank each task from lowest to highest EOU. For example, based on the average PEOU for each task across participants, the tasks were ranked from lowest to highest PEOU. FIG. 9 summarizes the rankings: Column 1, contains the baseline rank; Column 2 displays the rank obtained by averaging the PEOU for each task; Columns 3 through 5 show the rank obtained by averaging NAUC, NAD, and MD, respectively.

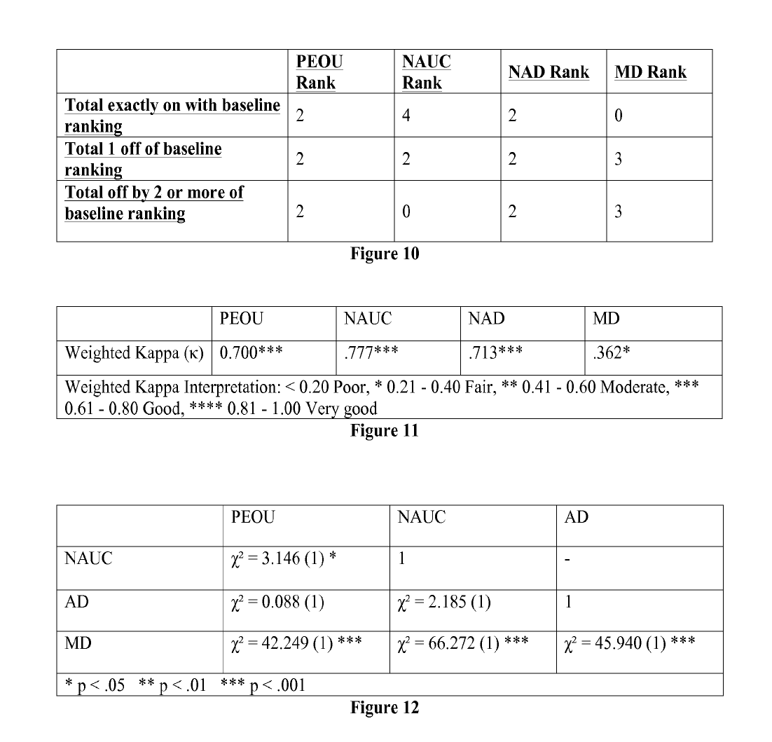

The consistency of each instrument—PEOU, NAUC, NAD, and MD—were statistically compared with the baseline rank. The count of rankings consistent with the baseline rank are shown in FIG. 10. To compare how consistently the PEOU, NAUC, NAD, and MD rankings coincided with the baseline ranking, the Weighted Kappa (i.e., inter-rater reliability) was calculated between each statistic (PEOU, NAUC, NAD, MD) and the baseline ranking (see FIG. 11). The weighted Kappa calculations indicated that PEOU (κ=0.700), NAUC (κ=0.777), and NAD (κ=0.713) all have good inter-rater reliabilities with the baseline ranking Whereas MD (κ=0.362) only has fair inter-rater reliability. Tests of Equality of Weighted Kappa indicated that the weighted Kappas for PEOU, NAUC, and NAD were significantly higher than the weighted Kappa for MD (p<0.001). In addition, the weighted Kappa for NAUC was significantly higher than the weighted Kappa for PEOU (p<0.05) (see FIG. 12 for the statistical comparisons).

Utility: There are many possible utilities for using the invention disclosed herein. One can select ease of use program including, but not limited to, web-site designing, online questionnaire form designing, or any other program that requires interactive input from a user. For example, methods of the invention can be used for conducting cost-effective usability testing of websites using NAUC and NAD, and thereby provides an approach for improving system design. Following a similar procedure outlined in Study 1, practitioners can compare different versions of a website, with NAUC and NAD providing a discriminant measure of EOU. Furthermore, following a similar procedure outlined in Study 2, practitioners can conduct a usability test to comparatively rank which components of a system likely have the highest EOU and which ones have the lowest EOU.

Because NAUC and NAD can be captured noninvasively via JavaScript embedded within a website and even unbeknownst to users, they can also be used for ongoing usability testing with live users, in their natural setting, and without threating the ecological validity of the interaction.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. A method for comparing the ease of use of a different versions of a computer program, said method comprising:
collecting input device usage characteristics of a user during an interactive computer session for each of a different version of computer programs; and
analyzing the input device usage characteristics of the user for each version of said computer program to determine the ease of use of said different versions of computer program.

2. The method of claim 1, wherein said input device comprises a point-and-click device.

3. The method of claim 1, wherein said input device comprises mouse, touch screen, track ball, touch pad, joystick, stylus, in-air sensor, or a combination thereof.

4. The method of claim 3, wherein said input device usage characteristics include, but are not limited to, normalized area under the curve, normalized maximum deviation, normalized additional distance, flips, pressure, cursor location, click latency, acceleration, speed, idle time, keystroke dwell time, keystroke transition time, areas of the page clicked on or hovered over, and a combination thereof.

5. The method of claim 1, wherein said step of analyzing the input device usage characteristics comprises comparing said input device usage characteristics of the user to a control input device usage characteristics.

6. The method of claim 5, wherein said control input device usage characteristics comprises input device usage characteristics of said user in a previous interactive computer session, or an earlier portion of the current session.

7. The method of claim 5, wherein said control input device usage characteristics comprises average input device usage characteristics of a plurality of users of the same computer program.

8. The method of claim 1, wherein said step of analyzing the input device usage characteristics comprises comparing said input device usage characteristics of the user to an idealized response trajectory.

9. The method of claim 1, wherein said computer program comprises a web-based.

10. A method for selecting an interactive computer software from different versions of said interactive computer software, said method comprising:
(i) collecting input device usage characteristics of a plurality of users using different versions of an interactive computer software;
(ii) analyzing the input device usage characteristics of the plurality of users for each versions of said interactive computer software; and
(iii) selecting a version of said interactive computer software having the highest ease of use score based on analysis of the input device usage characteristics for each versions of said interactive computer software.

11. The method of claim 10 further comprising the steps of modifying the interactive computer software and repeating said steps (i)-(iii).

12. The method of claim 10, wherein said interactive computer software comprises online interactive system.
